(19) United States
(12) Patent Application Publication
(10) Pub. No.: US 2016/0334309 A1
(43) Pub. Date: Nov. 17, 2016

(54) DEVICE AND METHOD FOR EXAMINING LAYER MATERIAL FOR CONTAMINATION

(71) Applicant: Airbus Defence and Space GmbH, Ottobrunn (DE)

(72) Inventors: Georg Wachinger, Ottobrunn (DE); Andreas Helwig, Ottobrunn (DE); Thomas Meer, Ottobrunn (DE); Matthias Geistbeck, Ottobrunn (DE); Alois Friedberger, Ottobrunn (DE); Sebastian Heckner, Ottobrunn (DE)

(21) Appl. No.: 15/151,723

(22) Filed: May 11, 2016

(30) Foreign Application Priority Data
May 11, 2015 (DE) 102015107341.2

(51) Int. Cl. G01N 1/22

(52) U.S. Cl. CPC G01N 1/2214

(57) ABSTRACT

A device used to examine layer material for contamination. The device comprises a heating device to heat a test area of the layer material and a detector device to detect at least one contaminant desorbed from the layer material. The heating device comprises at least one infra-red heating element. A method comprises heating a test area of the layer material and detecting at least one contaminant desorbed from the layer material. The heating takes place via an infra-red heating element.

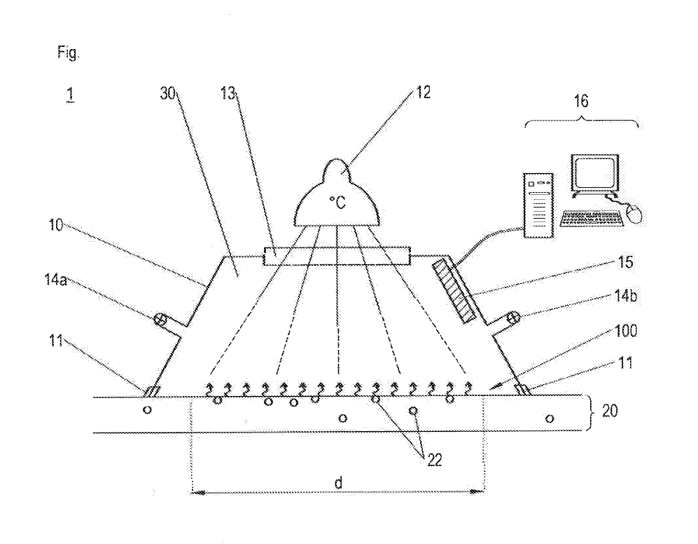

### CROSS-REFERENCES TO RELATED APPLICATIONS

This application claims the benefit of the German patent application No. 10 2015 107 341.2 filed on May 11, 2015, the entire disclosures of which are incorporated herein by way of reference.

### BACKGROUND OF THE INVENTION

The present invention relates to a device and a method for examining layer material for contamination.

During the production and use of layer material, in particular of elements comprising composite fiber plastics (such as carbon-fiber-reinforced plastic, for example) various substances that come into contact with the layer material (such as moisture, cleaning agents, antifreeze or de-icer, fuels, etc.) can diffuse into the layer material.

In particular, pre-impregnated, non-cured fiber matrix mats (what are known as “pre-pregs”) can absorb contamination, for example in the form of moisture, in this manner during transport, storage and/or handling. Absorption depends on the composition of the matrix, storage conditions and the climate conditions during manufacture.

Laminates produced from materials contaminated in this manner can have a disadvantageous, uneven structure, which for example includes air pockets, and they can be unsuitable for subsequent processing steps such as adhesive bonding, in particular.

Different types of contamination can be removed or at least reduced with counter measures. In particular, standardized, sometimes time-intensive cycles are used, for example, without determining in advance whether and to what extent a measure is actually required in a specific case. In the process, even negative effects of the measure on the subsequent component, which can arise at certain temperatures and with certain exposure times on the non-cured material, are often accepted (for example, disadvantageous viscosities or reaction states).

It is therefore important to be able to detect contamination of the material used.

The published document DE 10 2011 102 055 A1 discloses a device by means of which a cured composite fiber part can be checked for the presence of several particular contaminants. The device in particular comprises a surface-heating device and a sensor arrangement for detecting contaminants, which have been desorbed from the heated surface of the composite fiber part. In the document, a heating stamp, which rests on the substrate, and a halogen lamp are disclosed as such surface-heating devices.

A further approach is to detect moisture contamination of a test material with the aid of an infra-red sensor; this means that the material under examination does not need to be heated. A disadvantage of such a determination is, however, that only contamination of a top matrix resin layer (<100 μm from the surface) is detected, because the infra-red radiation is reflected at the fiber layer underneath. The moisture detected in each case depends highly on the moisture of the environment, which impairs the accuracy of the measurement. Furthermore, in this procedure the diffuse infra-red back-scattering through the fiber layers must also be taken into account, which likewise makes an exact determination of the contamination more difficult.

### SUMMARY OF THE INVENTION

The present invention is therefore based on an object of providing an improved technology with which contamination can be detected, in particular also in non-cured fiber matrix composite materials.

A device according to the invention is suitable for examining layer material for contamination. The device comprises a heating device for heating a test area of the layer material and a detector device for detecting at least one contaminant desorbed from the layer material. The heating device comprises at least one infra-red heating element.

A method according to the invention is suitable for examining layer material for contamination. It comprises heating a test area of the layer material with an infra-red heating element and detecting at least one contaminant desorbed from the layer material.

The layer material can have a plurality of layers or be designed to be layered for the production of a laminate. In particular, the layer material can comprise a pre-impregnated, non-cured fiber matrix mat (a “pre-preg”), which is designed to be layered to produce a laminate and then cured (for example, in an autoclave).

The infra-red heating element can, in particular, comprise an infra-red emitter. The heating according to the invention with the aid of the (preferably controllable) infra-red heating element allows contact-free heating (in particular) of a non-cured composite material that is not dimensionally stable (such as a pre-impregnated, non-cured fiber matrix mat) without heating the ambient air as well to a disadvantageous degree. In this manner, although desorption of contaminants can be thermally activated, impairment of the viscosity and the initial reaction state of the non-cured material resulting from heated ambient air can be avoided or at least minimized. A device according to the invention and a method according to the invention are therefore suitable for determining contamination in non-cured composite materials and allow parameters of any necessary countermeasures to be advantageously set. In this manner, defects in the laminate and on the surface can be prevented and thus the quality of the laminate, adhesive and surface of components produced from the material can be optimized.

In particular, the present invention makes it possible for any contamination present (for example a real moisture content) in a pre-impregnated fiber matrix mat (a “pre-preg”) to be determined during a laying process for manufacturing a laminate and/or for accompanying samples produced alongside manufacture to be examined accordingly.

The field of use of a device according to the invention and a method according to the invention is not limited to non-cured composite materials, however, but both device and method can also be used for examining other materials, in particular cured composite fiber materials (for example before further processing by adhesive bonding, coating or the like). The present invention therefore further has the advantage of flexible usability.

The test area can in each case be a total surface area of the layer material or a local surface section of the layer material; the layer material is examined on the test area.

According to a preferred embodiment of a device according to the invention, the detector unit comprises one or more sensors; the detection takes place analogously according to a method according to the invention preferably by means of such a detector unit. In particular, the detector unit can comprise for example, at least one moisture sensor, metal oxide sensor, non-dispersive infra-red sensor, at least one ion mobility spectrometer (IMS) and/or at least one gas chromatography sensor (which can for example have an ion mobility spectrometer as the detector). The measurement can comprise a determination of an absolute or relative quantity of the at least one contaminant in the measurement volume.

The detector unit preferably comprises a plurality of sensors that are each designed and configured to detect a different contaminant of a predefined selection of contaminants.

Particularly preferred is an embodiment of the device according to the invention in which the detector unit is designed and configured to quantify at least one contaminant desorbed from the layer material. Analogously, a particularly preferred variant of the method according to the invention comprises quantifying the at least one contaminant desorbed from the layer material.

The quantity values thus obtained for the contaminant in the layer material can, in particular, be used to determine and set suitable parameters of at least one countermeasure, with which detected and quantified contamination can be removed or reduced. Such parameters can be, for example, a duration of the measure or a temperature to which the later material is exposed as part of the counter measure.

An embodiment variant of the device according to the invention is preferred, in which the heating device is designed and configured to irradiate a partial-area of the test area simultaneously, the partial-area having a size of at least 100 cm2, more preferably at least 625 cm2 or even at least 900 cm2; analogously, according to a preferred embodiment of a method according to the invention, the heating comprises simultaneously irradiating a correspondingly sized partial-area of the test area. The irradiated partial-area can, for example, be substantially rectangular (for example, substantially square) or substantially a circular area.

The test area can thus be heated areally over a correspondingly sized expanse. This makes it possible to avoid disadvantageous local deformations of non-cured material that is not dimensionally stable, which can arise from only local heating (for example, on an area of only approximately 3 cm*3 cm) owing to the resulting high temperature gradient.

The heating device with the infra-red heating element is preferably part of a mobile, portable manual appliance. Particularly preferred is an embodiment in which the entire device according to the invention is part of such a mobile, portable manual appliance or at least has portable, mobile components. Such a device can be easily repositioned on the layer material while the layer material can be left in position, in particular for a random-sample-type examination of the material at a plurality of points. This is advantageous, in particular, for layer material that has a large area and is not dimensionally stable, and is difficult to move.

A device according to the invention comprises a measurement bell, which is designed and configured to form a measurement volume around the layer material or against the layer material, which volume adjoins the test area; the detector device then preferably detects the at least one contaminant in the measurement volume.

Analogously, according to a method according to the invention, the test area is preferably heated under such a measurement bell and the at least one contaminant is detected in the measurement volume therein.

The test area forms together with the measurement bell and where applicable with a further face (for example, an underlay) a boundary of the measurement volume (lying around or against it). For example, the measurement bell can be placed over the test area of the layer material or an underlay in any desired direction, or it can entirely enclose the layer material. In particular, the prepositional expression “under a measurement bell” should not be interpreted as suggesting a vertical orientation.

The measurement volume can form a geometric space of any desired shape (such as, for example, a sphere, a hemisphere, a cylinder, a truncated cone or a cuboid, to name only a few). In particular, the term of the “measurement bell” that defines the measurement volume should not be understood as a limitation of the geometry of the measurement volume.

In such embodiments comprising a measurement bell, an accuracy with which the at least one contaminant desorbed from the layer material is detected can in particular be improved, because at least some of the contaminant is captured in the measurement volume and thus is distributed in the environment to a limited extent at the most.

Furthermore, such a measurement bell can prevent the escape of gas that is harmful to health and/or smells bad, which may have developed as a result of the thermally activated desorption.

According to a preferred embodiment of the present invention, the measurement bell is at least one part of a portable manual appliance. In particular, the measurement bell can preferably have a diameter of at least 10 cm and/or no more than 50 cm, more preferably no more than 20 cm, and/or a mass of no more than 5 kg, more preferably no more than 1 kg.

Such a measurement bell can thus be easily repositioned, which, for example, makes it easier to carry out a random-sample-type examination of the layer material on several different test areas.

According to a preferred embodiment, such a measurement bell has an energy-permeable window, and the infra-red heating element is designed and configured to irradiate the test area through the window. In this manner, broad scattering of the infra-red light can be achieved by a suitable distance of the infra-red heating element from the test area, without the measurement volume having to be selected to be of corresponding size, which would reduce the accuracy of the detection of contaminant in the measurement volume.

Alternative or additionally, the device can comprise a purging device, which is designed and configured to purge the measurement volume with gas; analogously, a method according to the invention preferably comprises such purging.

Gas situated within the measurement volume is replaced by the purging. Preferably, a gas that has previously known properties is conducted into the measurement volume, in particular, the contamination of the gas with the at least one contaminant does not exceed a previously known threshold. According to a preferred embodiment, the gas is air, preferably synthetic air. This has the advantages of being particularly cost-effective, odorless, non-toxic and non-combustible.

Particularly preferred is an embodiment in which the detection of the at least one contaminant desorbed from the layer material takes place multiple times, specifically preferably after and before purging of the measurement volume.

This can make the detection more precise. During purging, contaminant that may have been desorbed previously from or through the test area of the layer material into the measurement volume is, in particular, removed from the measurement volume. The purging thus prevents the measurement volume from becoming saturated with the at least one contaminant In this manner, continued desorption of the at least one contaminant into the measurement volume is made possible and thus accurate detection of a contamination of the layer material is improved.

### BRIEF DESCRIPTION OF THE DRAWINGS

Preferred exemplary embodiments of the invention are explained in more detail below using a drawing. It is self-evident that individual elements and components can also be combined differently than shown.

The FIGURE shows a device according to an exemplary embodiment of the present invention.

### DETAILED DESCRIPTION OF THE PREFERRED EMBODIMENTS

The FIGURE schematically shows an arrangement (not to scale) that comprises an embodiment of a device 1 according to the invention.

The device comprises a measurement bell 10, which forms a measurement volume 30 adjacent to a layer material 20. In particular, the measurement volume 30 is enclosed by the measurement bell and a test area 100, which is part of a surface of the layer material 20. In particular, the test area 100 adjoins the measurement volume 30.

The measurement bell 10 has at the edge thereof a seal 11, which seals off the measurement volume at a transition between the measurement bell 10 and the test area 100.

The layer material 20 can, for example, comprise a non-cured fiber matrix composite material. It contains a contaminant 22 in its interior.

The device 1 also comprises an infra-red heating element 12 as the heating device, which is designed and configured to heat up the test area 100. As shown schematically, the infra-red heating element 12 irradiates a partial-area of the test area, which in the cross section shown has a diameter d; according to a preferred embodiment, d≧10 cm, more preferably d≧30 cm.

According to a preferred embodiment, the infra-red heating element 12 is controllable, flat and/or mobile.

In the exemplary embodiment shown, the heating device 12 is arranged outside the measurement bell 10 and heats the test area through an energy-permeable window 13 located in the measurement bell 10.

A purging unit 14a, 14b of the device 1 comprises a preferably controllable gas connection 14a and a gas outlet 14b and is designed and configured to conduct a predefined gas (for example synthetic air) through the measurement volume and in the process purge contaminant together with the gas situated in the measurement volume out of the measurement volume 30.

The device 1 also comprises a detector device 15 (having one or more sensors), which is designed and configured to measure contamination of the measurement volume 30 with (at least) the contaminant 22 qualitatively and/or quantitatively. Finally, the device 1 comprises a computation unit 16, which is connected to the detector device 15 and is designed and configured to suitably evaluate measured values detected by the detector device 15. Particularly preferred is an embodiment in which such a computation unit determines one or more parameters of a countermeasure, which is suitable to remove the at least one contaminant from the layer material, in an automated manner based on the values detected by the detector unit.

When the device is used, the test area 100 is then heated with the aid of the heating device 12, which effects desorption of the contaminant 22 from a layer of the test area close to the surface into the measurement volume 30, as indicated schematically by the arrows. The sensor system 15 measures the resulting contamination of the measurement volume, preferably several times, and forwards the values measured in each case to the computation unit 16.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE NUMBERS

1 Device
10 Measurement bell
11 Seal
12 Heating device with infra-red heating element
13 Window
14a, 14b Purging unit
15 Detector device
16 Computation unit
20 Layer material
22 Contaminant
30 Measurement volume
100 Test area
d Diameter of a partial-area

1. A device for examining layer material for contamination, comprising:
a heating device configured to heat a test area of the layer material, and
a detector device configured to detect at least one contaminant desorbed from the layer material,
the heating device comprising at least one infra-red heating element.

2. The device according to claim 1, wherein the heating device is configured to irradiate a partial-area of the test area simultaneously, wherein the partial-area has a size of at least 100 cm2.

3. The device according to claim 1, wherein the heating device is configured to irradiate a partial-area of the test area simultaneously, wherein the partial-area has a size of at least 625 cm2.

4. The device according to claim 1, wherein the heating device is configured to irradiate a partial-area of the test area simultaneously, wherein the partial-area has a size of at least 900 cm2.

5. The device according to claim 1, wherein the detector device is configured to quantify the at least one contaminant desorbed from the layer material.

6. The device according to claim 1, wherein the device is part of a mobile, portable manual appliance.

7. The device according to claim 8, further comprising a measurement bell, configured to form a measurement volume, which adjoins the test area, around or against the layer material.

8. The device according to claim 7, further comprising a purging device, configured to purge the measurement volume with gas.

9. The device according to claim 1, wherein the layer material comprises at least one of a non-cured fiber matrix composite material or a cured composite material.

10. A method for examining layer material for contamination, which comprises:
heating a test area of the layer material, and
detecting at least one contaminant desorbed from the layer material,
the heating taking place by means of an infra-red heating element.

11. The method according to claim 10, wherein the heating comprises simultaneous irradiation of a partial-area of the test area, wherein the partial-area has a size of at least 100 cm2.

12. The method according to claim 10, wherein the heating comprises simultaneous irradiation of a partial-area of the test area, wherein the partial-area has a size of at least 625 cm2.

13. The method according to claim 10, wherein the heating comprises simultaneous irradiation of a partial-area of the test area, wherein the partial-area has a size of at least 900 cm2.

14. The method according to claim 10, further comprising quantifying the at least one contaminant desorbed from the layer material.

15. The method according to claim 10, wherein the test area is heated under a measurement bell, which forms a measurement volume around the layer material or against the semi-finished product.

16. The method according to claim 15, further comprising purging the measurement volume with gas.
